(19) United States
(12) Patent Application Publication
(10) Pub. No.: US 2009/0092351 A1
(43) Pub. Date: Apr. 9, 2009

(54) HIGH DENSITY FIBER OPTIC ACOUSTIC ARRAY

(75) Inventors: Eric Lee Goldner, Valencia, CA (US); Leo Lam, Calabasas, CA (US); Graham Martin, Woodland Hills, CA (US); Kevin Ryu, Calabasas, CA (US)

Correspondence Address: FULWIDER PATTON LLP, HOWARD HUGHES CENTER, 6060 CENTER DRIVE, TENTH FLOOR, LOS ANGELES, CA, 90045, US

(73) Assignee: SABEUS, INC., CALABASAS, CA (US)

(21) Appl. No.: 12/096,010

(22) PCT Filed: Dec. 8, 2006
(86) PCT No.: PCT/US06/61812

§ 371 Date: Nov. 24, 2008

Related U.S. Application Data
(60) Provisional application No. 60/748,939, filed on Dec. 9, 2005.

(51) Int. Cl. G02B 6/02; G02B 6/00

(52) U.S. Cl. 385/12; 427/163.2

(57) ABSTRACT

A method for optimizing the architecture of a linear sensor array using WDM-TDM technology and stabilizing the reflectivity spectral profile of the fiber Bragg gratings of the sensors against the influence of environmental factors such as pressure and temperature is provided. The method includes stripping a portion of the foamed coating on the exterior of an optical fiber in the region of the fiber Bragg grating to thin the coating in the region of the grating. After the coating is stripped and the optical fiber cleaned, the area of stripped fiber is recoated with an unvoided plastic.

### BACKGROUND OF THE INVENTION

Arrays of fiber optic sensors are used for acoustic sensing within such applications as marine surveillance and perimeter security. Because of the high sensitivity and dynamic range typically required for these applications, interferometric sensors are often the optical instruments of choice. Fiber Bragg Gratings (FBGs) are widely used to provide the optical reflections within the interferometers, especially in the recently developed simplified low-cost single line array architecture, as shown in Kirkendall et al., Progress in Fiber Optic Acoustic and Seismic Sensing, Proceedings of the 18^{th} Optical Fiber Sensor Conference, Cancun, Mexico, October 2006, the subject matter of which incorporated by reference herein in its entirety.

As a general rule, improved performance of such a single line array system is obtained by adding more sensors to the system. Within towed arrays, including more sensors enables increased acoustic bandwidth and/or array gain and spatial averaging of some noise sources. Within stationary arrays, increasing the number of sensors in the array results in higher spatial resolution. Use of large numbers of sensors in a FBG sensor array is enable by using a combination of Wave Division Multiplexing (WDM) and Time Division Multiplexing (TDM). Such multiplexing systems, and the interrogators required to analyze the resultant output of such systems have been disclosed by Kirkendall et al in “Overview of high performance fibre-optic sensing”, J. Phys. D: Appl. Phys. 37 (2004) R197-R216, the subject matter of which incorporated by reference herein in its entirety.

However, two problems typically arise in the design of such arrays. The first problem is that the FBGs must be specially packaged to limit their spectral sensitivity to changes in ambient temperature and pressure. This limitation is important to ensure that the reflection spectra of the array remains coincident with the wavelengths of light emitted by the source laser. Such sensors are typically labor intensive to manufacture, requiring manual splicing and packaging, including assembly of concentric mandrels and pressure sealing of the sensors, and the like.

The second problem with such sensors is that due to limited optical power availability, optical crosstalk between sensors and high optical configuration and transmission losses, FBGs with reflectivities on the order of 1-5% are used as interferometer reflectors in acoustic sensor arrays. However, the use of such FBGs results in being able to incorporate very limited numbers of sensors per fiber per wavelength. Such systems are typically limited to including 1-4 sensors, and rarely are they able to include more than 6 sensors without experiencing significant loss of sensitivity due to crosstalk which results from multiple reflections that limit array gain an degrade narrow band array processing results.

This limitation is illustrated by the following analysis. For a hybrid WDM-TDM system including a linear acoustic array, let there be n_{w} wavelengths with each wavelength serving nₛ sensors. The total number of sensors N form the array is then:

N=n_{w}*nₛ eq. 1

For the purposes of this example, one criteria for acceptable crosstalk between the sensors of an array N sensors is given, in db units, by:

XT<−20 log(N−1)=−20*log(n_{w}*nₛ) eq. 2

However, the maximum inter-sensor optical crosstalk level in a single line TDM system with nₛ sensors is given by:

XT=20*log(sqrt((nₛ−1)(2nₛ−3/2))*R) eq. 3

where R is the reflectivity of each FBG in the array. Combining equations 2 and 3 above yields the relation between R and the parameters n_{w} and nₛ:

1/R>(nₛ*n_{w})*sqrt((nₛ−1)(2nₛ−3)/2) eq. 4

As one skilled in the art will immediately perceive, equation 4 can be solved for nₛ in terms of R and n_{w} to find the maximum number of sensor that can be served by a single wavelength. The results of such calculations are presented in FIGS. 1 and 2.

As can be seen in FIG. 1, when the FBG reflectivity is around 1-3%, the maximum number of sensors per wavelength per fiber is limited to 1-4. However, if the FBG reflectivity is limited to approximately 0.05%, this number quickly increases up to 24 with n_{w}>3. This greatly simplifies optical architecture requirements, and consequently labor costs associated with array assembly.

Similarly, FIG. 2 illustrates the number of sensors that can be included in an array as a function of FBG reflectivity, while maintaining an acceptable level of crosstalk between the sensors. As in FIG. 1, limiting to the FBG reflectivity to approximately 0.5 or less significantly increases the number of sensors that may be included in the array without significantly affecting the sensitivity of the array due to cross-talk between the sensors.

In a typical application, such as a towed sensor array, the fiber optic acoustic sensor arrays are formed by winding an optical fiber including regions in which FBGs are written, around a mandrel or core, which is then encased in a protective sheath or coating to protect the array during deployment and retrieval. In such an arrangement, the FBGs may become permanently bent when the sensors are wound around radii on the order of 0.5 inches in diameter.

FBGs located within uncoated optical fiber, that is, fiber that has only a thin, approximately 50-100 micron thick, plastic jacket formed from a material such as an acrylate typically have pressure sensitivity, measured in terms of wavelength shift of their reflection spectral peak, of approximately −0.03 pm/psi, temperature sensitivity of approximately 10-15 pm/° C., and are usually quite insensitive to bending stresses. However, for some acoustic sensing applications, the fiber is coated with voided plastic prior to construction of the array. In this case, the pressure sensitivity increases to on the order of 1 pm/psi, the temperature sensitivity increases to on the order of 30 pm/° C., and bending stress can be a few hundred parts per million. This magnitude of sensitivity loss can cause the FBG to be unusable for interferometric sensing applications, where the interrogating laser must have a wavelength near the center of the FBG reflection spectrum, and where the array is exposed to temperatures ranging from 0-35° C. and hydrostatic pressures from approximately 15 to 400 psi. To address this sensitivity loss, the current state of the art utilizes specially designed housings that isolate the FBGs from pressure and thermally compensate for the temperature sensitivity and are also designed to maintain the FBG in an unbent, and thus unstressed, condition. However, the cost of the associated packaging materials, labor and space can be significant.

What has been needed, and heretofore unavailable, is a fiber containing a FBG having a reduced sensitivity to bending, pressure and temperature, yet is rugged and can withstand rough handling, and can be wound with the fiber array assembly, without requiring special packaging or handling, thus realizing improved performance with reduced cost. The present invention fulfills these and other needs.

### SUMMARY OF THE INVENTION

In its broadest aspect, the present invention provides a method for simplifying the hybrid WDM-TDM architecture of a sensor array and reducing cost by minimizing the number of wavelengths used in a linear array of a fixed number of sensors. This is accomplished by forming FBGs having low reflectivity in the optical fiber and then coating the fiber to protect the FBGs such that they can be bent around a suitable mandrel or core without inappropriately adversely affecting the sensitivity of the array.

In another aspect, the present invention provides a method for altering the coating on an optical fiber incorporating FBGs to reduce the sensitivity of the optical fiber array to bending of the optical fiber, and to improve the acoustic performance of the fiber array by allowing the use of low reflectivity FBGs. In various aspects, the method includes thinning and recoating of the optical fiber in the area of the FBGs to achieve these improvements.

In another aspect, the method for improving the performance of a fiber optic grating used in an acoustic array includes removing an outer coating from a portion of an optical fiber having a fiber Bragg grating formed therein, and coating the portion of the optical fiber where the outer coating is removed with a non-voided plastic material. In another aspect, removing the outer coating includes dipping the portion of optical fiber in an acid, and in yet another aspect, the fiber is dipped into an acid bath where the acid is at an increased temperature, such as 100° C. In still another embodiment, the acid is sulfuric acid.

In a further aspect of the present invention, the method includes removing residual acid from the optical fiber before coating the portion of the optical fiber where the outer coating is removed with a non-voided plastic material. In a still further aspect, the acid is removed by exposing the stripped region of the optical fiber to a solvent, such as, for example, isopropyl alcohol. In still another aspect, the isopropyl alcohol is vibrated at ultrasonic frequencies.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is a graph depicting the maximum number of sensors that can be served per wavelength as a function of the FBG reflectivity and the number of wavelengths used.

FIG. 2 is a graph depicting the total number of sensors in an array as a function of the FBG reflectivity and the number of wavelengths used.

FIG. 3 is a longitudinal cross-sectional view of a length of optical fiber including a FBG incorporated into a linear sensor array.

FIG. 4 is a longitudinal cross-sectional view of the optical fiber of FIG. 3 illustrating the removal of a portion of the outer coating of the optical fiber using methods in accordance with the present invention.

FIG. 5 is a side view of tank, partly in cross-section, illustrating an embodiment of the methods of the present invention used to selectively remove the portion of the outer coating of the optical fiber of FIG. 4.

FIG. 6 is a longitudinal cross-sectional view of the optical fiber of FIG. 3 showing the fiber after re-coating with an adhesive in the area of coating removal to seal the optical fiber and provide protection to the fiber.

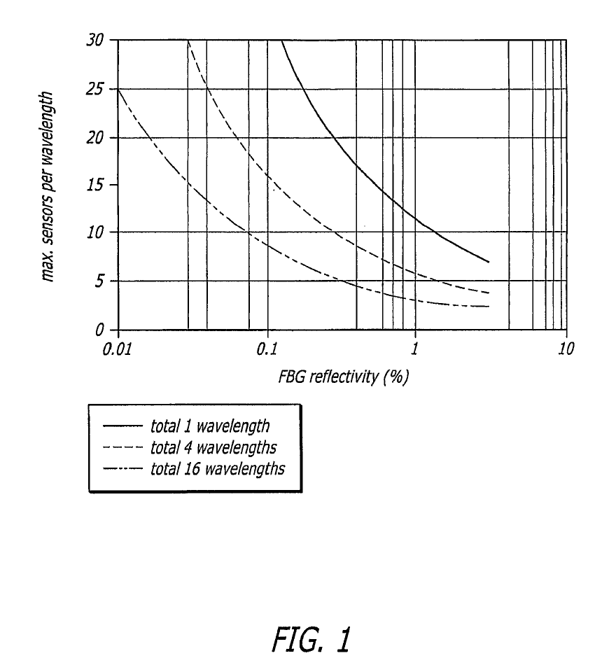

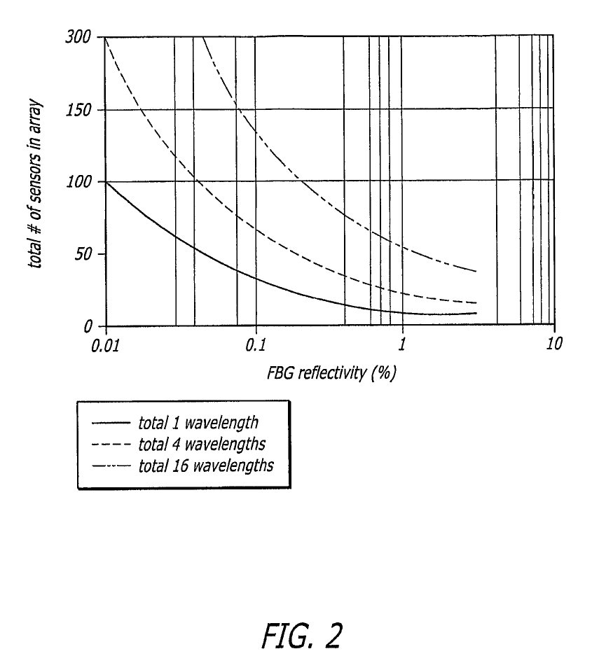

### DETAILED DESCRIPTION OF THE PREFERRED EMBODIMENTS

Referring now to the drawings in detail, in which like reference numerals indicate like or corresponding elements among the several figures, in a presently preferred embodiment, an optical fiber that is intended for use in an acoustic array is coated with a plastic material that is foamed to enhance the acoustic sensitivity of the fiber using an extrusion process which allows very long lengths of fibers, on the order of kilometers, to be coated in a rapid, low cost process. This process, however, results in an optical sensor array that has unsuitable sensitivity to changes in pressure, temperature or bending, that is stressing, of the fiber.

Simply removing all of the coating in the vicinity of the FBGs forming the sensor array incorporated into the optical fiber reduces the magnitude of the aforementioned sensitivities, but presents several problems. First, the thick plastic material that is typically used to coat the optical fiber is difficult to remove from the optical fiber using mechanical methods, such as a sharp blade or other stripping tool, or thermal methods, such as, for example, controlled melting or carbonization of the coating, without breakage of the fiber. Second, many optical fibers also include cladding or other necessary inner jackets or coatings from the fiber. Thus, removal of all of the plastic coating is also likely to remove these other layers, thereby leaving the glass susceptible to fracture induced by the presence of water and/or water vapor. Third, removal of all of the coating in the vicinity of the FBG creates regions of significant bending stress at the boundaries of the stripped region that leave the fiber vulnerable to breakage, increasing the likelihood of mechanical failure at those locations. The various embodiments of the present invention avoid these problems by removing the plastic outer coating using a rapid, repeatable, low cost process which preserves the critical parameters of the FBGs and the fiber, such as the tensile strength and flexibility of the fiber.

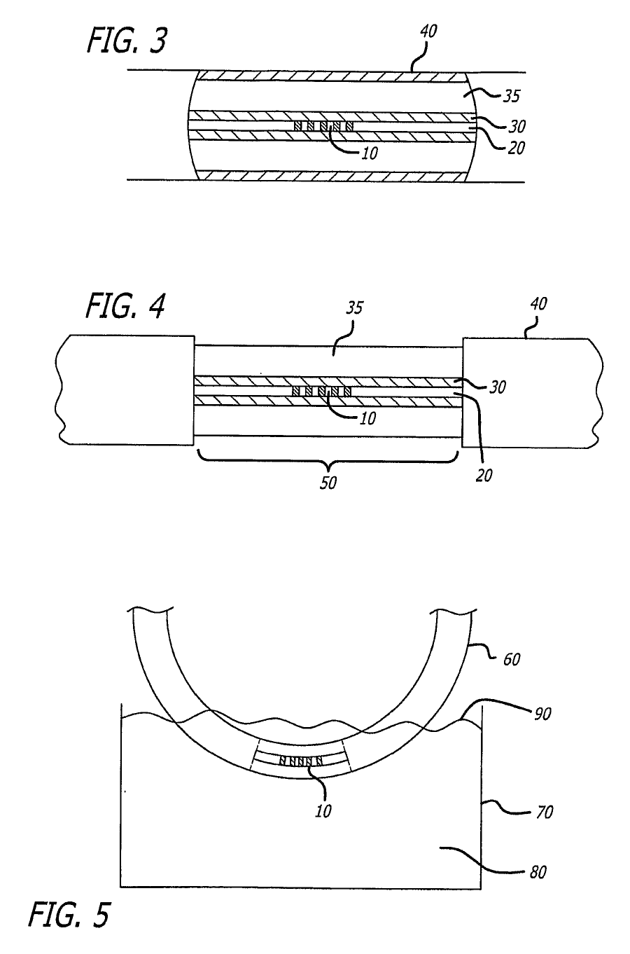

FIG. 3 depicts a typical structure of an optical fiber including an FBG formed within the fiber that is used in a sensor array such as is contemplated herein. As shown, the FBG 10 is typically formed in the core 20 of the optical fiber, which is surrounded by at least one cladding or protective layer 30. The core and cladding layers are in turn surrounded by a foamed core 35 which is protected by protective sheath 40 that may be formed, as mentioned above, from a hard plastic material that is chosen to both protect the optical fiber encased within as well as to provide necessary engineering and structural characteristics, such as resistance to water or chemicals, tensile strength, bend resistance and the like, as determined by the performance requirements of the expected use of the optical fiber. Those skilled in the art will understand that the structure of the optical fiber depicted in FIG. 3 has been simplified for illustration purposes, and that other structures may also be included between the outer sheath and the optical fiber itself to provide strength, acoustic properties or other properties as needed for the fiber sensor array to perform satisfactorily in a given application.

In one embodiment of the present invention, as depicted in FIG. 4, a small section 50 of the protective sheath or coating of the optical fiber is removed from the fiber in the vicinity of the FBG 10 over a length, for example that extends 1-2″ beyond the outside boundary of the FBG 10. The removal of the sheath or coating reduces the stiffness of the optical fiber assembly in the area of the FBG.

In a presently preferred embodiment, the removal of the sheath or coating is accomplished using a concentrated solution of sulfuric acid at a temperature elevated above ambient, typically at a temperature of approximately 100° C. As depicted in FIG. 5, To remove the coating, the fiber assembly 60 is bent in a very shallow “U” shape, with the FBG 10 centered at the bottom of the “U” (shown in phantom). This segment of the fiber assembly 60 is then dipped a bath 70 containing heated sulfuric acid 80 at a slow, defined rate, until a pre determined length of the fiber assembly 60 is immersed below a surface level 90 of the sulfuric acid 80, and then removed at the same rate. The tough skin layer of the foamed plastic sheath or coating, created as part of the extrusion process of the fiber assembly, and a few hundred microns of the foam portion of the coating is removed. The immersion and removal rate of the fiber assembly will be dependent upon the composition of the sheath or coating and the foamed core of the coating, and the amount of foam core that is desired to remove.

Following the acid stripping, the stripped region 50 (FIG. 4) of the fiber is cleaned using a suitable solvent or cleaning solution, such as, for example, isopropyl alcohol. The cleaning step may be accomplished using a variety of techniques, although ultrasonic cleaning is presently preferred.. This process ensures complete removal of the sulfuric acid to 1) prevent further immediate stripping; and 2) prevent residual acid from causing further, long-term stripping of the plastic coating. The result of the stripping process is a sheath or coating 40 whose total thickness smoothly tapers between the location where the stripping starts to the location of the FBG 10.

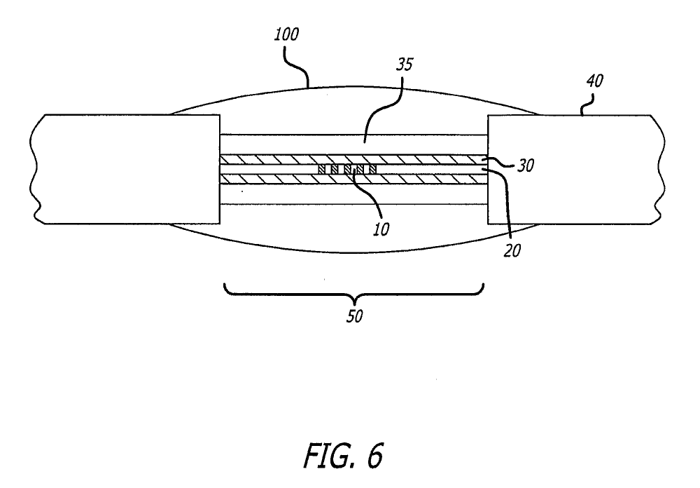

Finally as illustrated in FIG. 6, a thin layer of polyurethane adhesive 100, such as an unvoided polyurethane or other plastic, is applied over the stripped region 50, including the area surrounding the FBG 10. This layer of adhesive ensures a good seal against water or other contaminants. The adhesive layer 100 is shown as slightly overlapping the boundaries of the stripped region 50 for illustration purposes. In practice, such an overlap would be minimized to ensure a relatively uniform overall thickness of the fiber assembly so as to prevent any interference with deployment or retrieval of the fiber assembly.

The post coating treatment of the FBGs with the adhesive also ensures a reduced FBG sensitivity to bending, pressure and temperature, yet ensures there are no sudden discontinuities in the dimensions or stiffness of the fiber coating that could otherwise be locations for failure. The result is a fiber containing an FBG which has reduced temperature and pressure sensitivity and is also very rugged against handling, and can be wound with the remainder of the fiber during array assembly, with no other special packaging or handling required.

The various embodiments of the invention thus solve the problems described above by incorporation of the following novel design approaches because it provides a fiber having reduced sensitivity to bending, allowing the sensing fiber to be wound onto an acoustically non-responsive structure, and allow use of low (˜0.05%) reflectivity FBGs which allows for use of more FBGs per wavelength.

While several particular forms of the invention have been illustrated and described, it will be apparent that various modifications can be made without departing from the spirit and scope of the invention.

We claim:

1. A method for improving the performance of a fiber optic grating used in an acoustic array, comprising:
removing an outer coating from a portion of an optical fiber having a fiber bragg grating formed therein;
coating the portion of the optical fiber where the outer coating is removed with a non-voided plastic material.

2. The method of claim 1, wherein removing the outer coating includes dipping the portion of optical fiber in an acid.

3. The method of claim 2, further comprising removing residual acid from the optical fiber before coating the portion of the optical fiber where the outer coating is removed with a non-voided plastic material.

4. The method of claim 1, wherein the outer coating of the optical fiber is a foamed plastic material.

5. A product formed by the process of claim 1.

6. A method of manufacturing a linear sensor array having a hybrid WDM-TDM architecture, comprising:
providing a sensor array having a fixed total number of sensors, each sensor including an FBG having a reflectivity that is optimized to allow a minimum number of wavelengths to be used without reducing the sensor array's performance.
